(19) United States
(12) Patent Application Publication
(10) Pub. No.: US 2026/0121882 A1
(43) Pub. Date: Apr. 30, 2026

(54) Port Property Synchronization in Multi-Homed Network for Multicasting

(71) Applicant: Cisco Technology, Inc., San Jose, CA (US)

(72) Inventors: Mankamana Prasad Mishra, San Jose, CA (US); Lei Feng, Cary, NC (US); Vinish Ramachandran, BANGALORE (IN); Kiran Prakash, RESEARCH TRIANGLE PARK, NC (US); Ming Zhao, STAMFORD, CT (US); Mallikarjuna R. Boggala, RESEARCH TRIANGLE PARK, NC (US)

(21) Appl. No.: 18/932,406

(22) Filed: Oct. 30, 2024

(51) Int. Cl. H04L 12/18; H04L 12/46

(52) U.S. Cl. CPC H04L 12/185; H04L 12/4641

(57) ABSTRACT

Devices, networks, systems, methods, and processes for synchronizing a port property in a multi-homed communication network for multicasting are provided herein. The multi-homed communication network may include peer network devices and a host device that is multi-homed to the peer network devices. If a port of a network device of the peer network devices is coupled to a multicast source via the host device, the network device may update the port property of its port. Further, the network device may generate and forward a notification message including the updated port property to its peer network device to make the port property consistent between the peer network devices. Accordingly, if the network device fails to transmit a multicast join message for a multicast query message, the forwarded notification message may configure the peer network device to act as a proxy for the network device to forward the multicast query message.

The present disclosure relates to communication networks. More particularly, the present disclosure relates to synchronizing port properties between peer network devices in a multi-homed Ethernet virtual private network (EVPN) for multicasting.

### BACKGROUND

Ethernet Virtual Private Network (EVPN) is widely utilized in network deployments, with EVPN-based all-active multi-homing emerging as a building block of next-generation network infrastructure. This approach is particularly valuable in various multicasting applications such as video conferencing, streaming media, online gaming, or the like. In these applications, EVPN is utilized to extend Layer 2 (L2) host networks through an intermediate Layer 3 (L3) network, ensuring that traffic between the host networks remains private. Specifically, EVPN facilitates transmission of L2 communications, such as Ethernet packets or “frames,” between the host networks via the intermediate L3 network. These host networks typically include host devices, multicast sources, and multicast receivers, while the intermediate L3 network comprises network devices.

In a typical configuration, these host devices may be multi-homed to two or more network devices (for example, provider edge devices) to provide redundancy and prevent network failures, such as network device failures, link failures between host devices and network devices, etc. However, while the multi-homing feature of EVPN offers redundancy and reliability, it can also introduce challenges to existing multicasting protocols. One such issue is that a multicast receiver might not receive the necessary multicast traffic flow from a multicast source.

Generally, a multicast source may send a multicast query message to a network device through a host device and wait for a multicast join message to transmit a multicast traffic flow. Upon receiving the multicast query message, the network device updates its port properties to forward the multicast join message once the multicast join message arrives from a multicast receiver. Further, in EVPN with the multi-homing feature-enabled, the network device may execute a Designated Forwarder (DF) election process to determine which network device among multiple network devices multi-homed to the host device should handle the multicast traffic flow. Occasionally, the network device might designate a DF whose port properties have not been updated to forward the multicast join message. As a result, even if the network device receives the multicast join message, it may fail to forward the multicast join message due to a non-DF state. Further, the DF may also fail to forward the multicast join message since its port properties are not updated. Consequently, the multicast join message may not reach the multicast source, leading to the multicast receiver failing to receive the required multicast traffic flow. Thereby, resulting in connection failures between multicast sources and multicast receivers.

### SUMMARY OF THE DISCLOSURE

Systems and methods for synchronizing port properties between peer network devices in a multi-homed Ethernet virtual private network (EVPN) network for multicasting in accordance with embodiments of the disclosure are described herein. In many embodiments, a network device, comprising one or more ports, a processor, and a memory communicatively coupled to the processor, is provided. The memory comprises a port property synchronizing logic that is configured to receive, via a port of the one or more ports, a multicast query message from a host device. The host device is coupled to a multi-homing set including the network device and a peer network device. The port property synchronizing logic is further configured to update at least one port property of the port based on the reception of the multicast query message at the port, generate a notification message including an Ethernet Segment Identifier (ESI) associated with the port and the updated at least one port property of the port, and transmit the generated notification message to the peer network device.

In a number of embodiments, the ESI indicates an Ethernet Segment (ES) associated with the port on which the multicast query message is received.

In a variety of embodiments, the notification message further includes an Ethernet Virtual private network Instance (EVI) identifier indicating an EVI on which the multicast query message is received.

In more embodiments, the port property synchronizing logic is further configured to receive a multicast join message from a new host device, generate a multicast join synch message based on the multicast join message, and transmit the generated multicast join synch message to the peer network device.

In additional embodiments, the multicast join synch message includes at least one of a new ESI associated with the multicast join message or an Ethernet Virtual private network Instance (EVI) identifier associated with the multicast join message.

In further embodiments, the port property synchronizing logic is further configured to determine that a state of the port corresponds to a non-designated forwarder (DF) state, and drop the received multicast join message based on the determination that the state of the port corresponds to the non-DF state.

In still more embodiments, the notification message is configured to synchronize the updated at least one port property with another port of the peer network device that is associated with the ESI.

In still further embodiments, the updated at least one port property indicates the port as a Multicast router (Mrouter) port.

In some more embodiments, the multicast query message corresponds to an Internet Group Management Protocol (IGMP) query message.

In yet more embodiments, the multicast query message corresponds to a Protocol Independent Multicast (PIM) hello message.

In still yet more embodiments, a network device, comprising one or more ports, a processor, and a memory communicatively coupled to the processor, is provided. The memory comprises a port property synchronizing logic that is configured to receive, from a peer network device, a notification message including an Ethernet Segment Identifier (ESI) and at least one port property. The network device and the peer network device belong to a multi-homing set coupled to a host device. The port property synchronizing logic is further configured to identify, from the one or more ports, a port associated with the ESI and associate the identified port with the at least one port property.

In many further embodiments, the at least one port property corresponds to a Multicast router (Mrouter) port property.

In many additional embodiments, to associate the identified port with the at least one port property, the port property synchronizing logic is further configured to mark the identified port as an Mrouter port.

In still yet further embodiments, the port property synchronizing logic is further configured to receive a multicast join synch message from the peer network device and transmit, via the Mrouter port to the host device, a proxy report based on the multicast join synch message.

In still yet additional embodiments, the port property synchronizing logic is further configured to determine that a state of the Mrouter port corresponds to a designated forwarder (DF) state and transmit, via the Mrouter port, the proxy report to the host device based on the determination that the state of the Mrouter port corresponds to the DF state.

In several embodiments, the port property synchronizing logic is further configured to receive, from the host device via the Mrouter port, a multicast traffic flow based on the transmitted proxy report.

In several more embodiments, the port property synchronizing logic is further configured to update a snooping table based on the reception of the multicast join synch message.

In numerous embodiments, to associate the identified port with the at least one port property, the port property synchronizing logic is further configured to mark the identified port as a non-Mrouter port.

In numerous additional embodiments, the ESI indicates an Ethernet Segment (ES) on which a multicast query message is received from the host device.

In further additional embodiments, a method is provided. The method comprises including, in a network device, one or more ports, and receiving, via a port of the one or more ports, a multicast query message from a host device. The host device is coupled to a multi-homing set including the network device and a peer network device. The method further comprises updating at least one port property of the port based on the reception of the multicast query message at the port, generating a notification message including an Ethernet Segment Identifier (ESI) associated with the port and the updated at least one port property of the port, and transmitting the generated notification message to the peer network device.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual diagram of a communication network in accordance with various embodiments of the disclosure;

FIG. 2 is a conceptual diagram of a communication network for synchronizing port properties in accordance with various embodiments of the disclosure;

FIG. 3 is a conceptual diagram of a communication network for a multicast traffic flow transmission in accordance with various embodiments of the disclosure;

FIG. 4 is a flowchart depicting a process for transmitting a notification message to a peer network device in accordance with various embodiments of the disclosure;

FIG. 5 is a flowchart depicting a process for transmitting a multicast join synch message to the peer network device in accordance with various embodiments of the disclosure;

FIG. 6 is a flowchart depicting a process for updating a snooping table in accordance with various embodiments of the disclosure;

FIG. 7 is a flowchart depicting a process for marking a port either as an Mrouter port or a non-Mrouter port in accordance with various embodiments of the disclosure;

FIG. 8 is a flowchart depicting a process for transmitting a proxy report or prohibiting the transmission of the proxy report in accordance with various embodiments of the disclosure; and

FIG. 9 is a conceptual block diagram of a device suitable for configuration with a port property synchronizing logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein to manage connections between Layer 2 (L2) host networks that are deployed in an Ethernet virtual private network (EVPN) (specifically, a multi-homed EVPN) for multicasting. This multi-homed EVPN may be utilized to extend the L2 host networks through an intermediate Layer 3 (L3) network to ensure that traffic between the host networks remains private. Typically, the L2 host networks include host devices, multicast sources, and multicast destinations, while the intermediate L3 network comprises network devices. As used herein, the host devices may include routers, switches, customer edge devices, or the like. As used herein, the multicast destinations may include devices (or applications) that subscribe to a specific multicast destination group and receive a multicast traffic flow transmitted to the specific multicast destination group. As used herein, the multicast sources may include devices (or applications) that transmit the multicast traffic flow to the specific multicast destination group. Further, as used herein, the multicast traffic flow may correspond to a Broadcast, Unknown-unicast, and Multicast (BUM) traffic flow. As used herein, the network devices may include routers, switches, provider edge devices, or the like.

In a typical configuration, these host devices may be multi-homed to two or more network devices to provide redundancy and prevent network failures. However, while the multi-homing feature of EVPN offers redundancy and reliability, it can also introduce challenges to existing multicasting protocols. One such issue is that a multicast destination might not receive the necessary multicast traffic flow from a multicast source.

Generally, a multicast source may send a multicast query message to a network device through a host device and wait for a multicast join message to transmit the multicast traffic flow. For example, the multicast query message may correspond to an Internet Group Management Protocol (IGMP) query message, a Protocol Independent Multicast (PIM) hello message, or the like. In an example, the multicast join message may correspond to an IGMP membership request message, a PIM join request message, or the like. Upon receiving the multicast query message, the network device may update its port properties to forward the multicast join message once the multicast join message arrives from a multicast destination.

Further, in EVPN with the multi-homing feature-enabled, the network device may execute a Designated Forwarder (DF) election process to determine which network device among multiple network devices associated with the host device (e.g., multi-homed to the host device) should handle the multicast traffic flow. In many scenarios, the network device might designate a DF whose port properties have not been updated to forward the multicast join message. As a result, even if the network device receives the multicast join message, it may fail to forward the multicast join message due to a non-DF state. Further, the DF may also fail to forward the multicast join message since its port properties are not updated. Consequently, the multicast join message may not reach the multicast source, leading to the multicast destination failing to receive the required multicast traffic flow. Thereby, resulting in connection failures between the multicast source and the multicast destination.

Therefore, the present disclosure provides a network device (e.g., a router, a switch, or a provider edge device) that synchronizes its port properties with its peer network devices to manage the connections between a multicast source and a multicast destination. In many embodiments, when a port of the network is coupled to the multicast source, the network device may update a port property of its port. In many further embodiments, the coupling of the port to the multicast source may be detected by receiving the multicast query message such as the IGMP query message, the PIM hello message, or the like. In many additional embodiments, the coupling of the port to the multicast source may be detected based on a reception of a user request for coupling the port to the multicast source.

As used herein, the port property may refer to a specific configuration or attribute assigned to the port, which determines a behavior or capabilities of the port within a communication network. For example, the port property may include an Mrouter port property, a security property, or an Access Control List (ACL) property. The Mrouter port property may configure the port either as an Mrouter port or a non-Mrouter port. The security property may configure the port to either allow or restrict the multicast traffic flow to/from a specific Media Access Control (MAC)/Internet Protocol (IP) address. The ACL property may be associated with a list of access controls for allowing the multicast traffic flow to/from a particular ethernet segment (ES). In an example, upon detecting the port is coupled to the multicast source, the network device may update the Mrouter port property of the port to configure the port as the Mrouter port. As used herein, the Mrouter port may correspond to a network port of a network device that is designated to interface with one or more multicast sources. Additionally, or alternatively, the network device may update the security property of the port to configure the port to allow the reception of the multicast traffic flow from the multicast source. Additionally, or alternatively, the network device may update the ACL property of the port to adjust the list of access controls of the port to allow the multicast traffic flow to be received from an ES connected to the port.

In more embodiments, the network device may synchronize the updated port property with at least one peer network device. In order to synchronize the updated port property with the peer network device, the network device may generate and transmit a notification message including the updated port property to the peer network device. The network device and the peer network device may be coupled to the host device via a set of ESs. These ESs may be provided with an Ethernet Segment Identifier (ESI) to uniquely identify the ESs in the communication network. In several more embodiments, the notification message may also include the ESI indicating an ES on which the multicast query message was received. In still more embodiments, the network device and the peer network device may participate in EVPN Instance (EVI) associated with the communication network. As used herein, the EVI may correspond to an EVPN routing and forwarding instance that spans all network devices participating in that EVPN. In these embodiments, the network device and the peer network device may be provided with an EVI identifier to uniquely identify the network device and the peer network device participating in the EVI. In still yet more embodiments, the notification message may further include the EVI identifier indicating an EVI on which the multicast query message was received.

In further embodiments, the peer network device may receive the notification message from the network device. The reception of the notification message may trigger the peer network device to synchronize its port property with the network device. In order to synchronize its port property with the network device, the peer network device may identify a port from corresponding one or more ports. In still further embodiments, the port may be identified based on the ESI included in the notification message. For example, the peer network device may identify, from the one or more ports, one such port that is associated with an ES having the ESI. In still yet further embodiments, the peer network device may associate the updated port property with the identified port. For example, if the updated port property corresponds to the Mrouter port property and the Mrouter port property indicates the port of the network device as the Mrouter port, the peer network device may also mark the identified port as the Mrouter port. Conversely, if the Mrouter port property indicates the port of the network device as the non-Mrouter port, the peer network device may mark the identified port as the non-Mrouter port. Similarly, when the updated port property corresponds to the security property or the ACL property, the peer network device may update a security property or an ACL property of the identified port based on the updated port property. Thereby, the port property of the network device is made consistent with the port property of the peer network device.

In a number of embodiments, the network device may further receive a multicast join message from a host device associated with the multicast destination. For example, the multicast join message may correspond to an IGMP membership request message, a PIM join request message, or the like. In an example, the multicast join message may include a source address indicating the multicast source, or a multicast destination group address indicating a multicast destination group that the multicast destination has requested to join. Upon receiving the multicast join message, the network device may update its snooping table. In order to update the snooping table, the network device may identify, from corresponding ports, a port at which the multicast join message was received and map the identified port with the multicast destination group address included in the multicast join message. As used herein, the snooping table may be a data structure that stores multicast source addresses, multicast destination group addresses, or information about network ports. The information about the network ports may include the mappings of the network ports to MAC addresses, IP addresses, or the multicast destination group addresses.

In a variety of embodiments, upon receiving the multicast join message, the network device may be triggered to synchronize the multicast join message with the peer network device to ensure the network device and the peer network device have a consistent view of MAC addresses, IP routes, or ESs. In order to synchronize the multicast join message with the peer network device, the network device may generate and forward a multicast join synch message to the peer network device. The multicast join synch message may include a new ESI indicating an ES on which the multicast join message was received, the source address, or the multicast destination group address.

In numerous embodiments, the peer network device may receive the multicast join synch message from the network device. Upson receiving the multicast join synch message, the peer network device may be triggered to synchronize a corresponding snooping table with the snooping table of the network device. In an example, to synchronize its snooping table with the snooping table of the network device, the peer network device may identify, from corresponding ports, a port that is associated with the new ESI included in the multicast join synch message and map the identified port with the multicast destination group address included in the multicast join synch message.

Since the network device and the peer network device are in the multi-homed EVPN, the network device and the peer network device may end up performing redundant transmission of the multicast join message to the multicast source. Accordingly, in additional embodiments, the network device or the peer network device may execute a Designated Forwarder (DF) election process to avoid the redundant transmission of the multicast join message. This DF election process may be executed to designate one of the network device or the peer network device to transmit the multicast join message to the multicast source. Additionally, the DF election process may be executed by the network device and the peer network device if a port of the network device fails to operate.

In an example, when the network device is designated as a DF for transmitting the multicast join message, the network device may forward the multicast join message towards the multicast source via the Mrouter port. Conversely, if the peer network is designated as the DF or otherwise non-designated, the network device may drop the multicast join message in anticipation that the peer network would forward the multicast join message. In still additional embodiments, if the peer network device is designated as the DF, the peer network may act as a proxy for the network device to transmit the multicast join message to the multicast source. Specifically, the peer network device may forward the multicast join message towards the multicast source via the Mrouter port that is synchronized by the reception of the notification message.

Advantageously, transmitting the notification message to the peer network device may trigger the peer network device to synchronize at least one port property of its port with at least one property of the port of the network device. Further, the transmission of the multicast join synch message to the peer network device may trigger the peer network device to synchronize its snooping table with the snooping table of the network device. Accordingly, when the network device fails to transmit the multicast join message to the multicast source, the peer network device may act as a proxy for the network device to transmit the multicast join message to the multicast source. Consequently, the multicast join message may reach the multicast source. Thus, leading to the suppression of the connection failures between the multicast destination and the multicast source.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

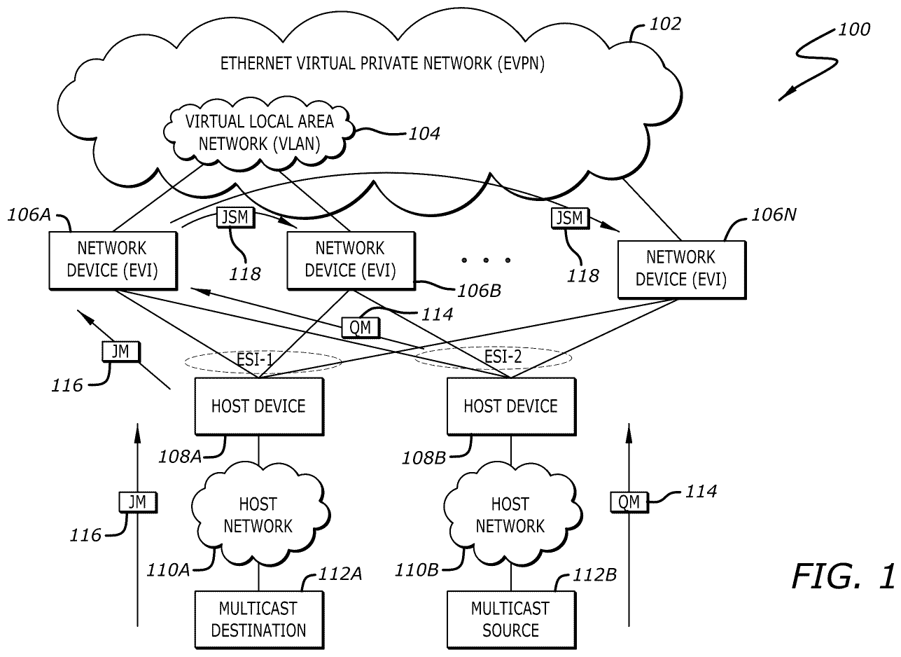

Referring to FIG. 1, a conceptual diagram of a communication network 100 in accordance with various embodiments of the disclosure is shown. The communication network 100 may include an Ethernet Virtual Private Network (EVPN) 102. In numerous embodiments, the EVPN 102 may be configured to connect two or more host networks that are located, for example, in different geographic locations. In the embodiments shown in FIG. 1, the EVPN 102 may be configured to connect a host network 110A with a host network 110B or vice versa. In numerous additional embodiments, the EVPN 102 may connect the host networks 110A and 110B in such a manner that these host networks 110A and 110B are unaware of the intervention of the EVPN 102. In fact, the EVPN 102 may enable the host networks 110A and 110B to operate as if these host networks 110A and 110B were directly connected. The EVPN 102 may be a Layer 3 (L3) computer network that supports L3 operations as described in the Open Systems Interconnection (OSI) model. For example, the L3 operations may include operations performed by L3 protocols such as the Internet Protocol (IP). In a variety of embodiments, the EVPN 102 may be a publicly accessible computer network that is owned and operated by a service provider, for example, a large telecommunication entity or corporation.

In various embodiments, the EVPN 102 may include or may be associated with a plurality of network devices. In the embodiments shown in FIG. 1, the EVPN 102 may include network devices 106A-N. For example, the network devices 106A-N may be interconnected within the EVPN 102 using Multi-Protocol Label Switching (MPLS) protocols such as Label Distribution Protocol (LDP), Label Switched Path (LSP), or the like. The network devices 106A-N may include N number of network devices, where N is an integer greater than 1. For example, the network devices 106A-N may correspond to routers, switches, provider edge devices, or the like. These network devices 106A-N and the EVPN 102 may correspond to an overlay or a logical layer of the communication network 100. As used herein, the logical layer (or the overlay layer) may correspond to a virtual network built on top of a network infrastructure layer, where the virtual network enables various logical connections that are independent of physical connections for allowing more flexibility and scalability of the communication network 100.

In several embodiments, the EVPN 102 may include at least one EVPN Instance (EVI). As used herein, the EVI may correspond to an EVPN routing and forwarding instance that spans all network devices participating in that EVPN. The EVI may include one or more broadcast domains. In the embodiments shown in FIG. 1, the one or more broadcast domains may correspond to a Virtual Local Area Network (VLAN) 104. In several more embodiments, an Ethernet tag identifier may be provided for the VLAN 104 to uniquely identify the VLAN 104 in the EVPN 102. Specifically, the Ethernet tag identifier may be provided for network devices participating in the VLAN 104. For example, the Ethernet tag identifier (denoted as “EVI” in FIG. 1) may be provided to the network devices 106A and 106B associated with the VLAN 104.

In many embodiments, the communication network 100 may include a plurality of host networks. In the embodiments shown in FIG. 1, the communication network 100 may include the host networks 110A and 110B. These host networks 110A and 110B may be owned and operated by an end-user organization or individual. For example, the host networks 110A and 110B may correspond to Local Area Networks (LANs). In many additional embodiments, the host networks 110A and 110B may include or may be associated with a plurality of host devices. In the embodiments shown in FIG. 1, the host networks 110A and 110B may be associated with host devices 108A and 108B, respectively. For example, the host devices 108A and 108B may correspond to routers, switches, customer edge devices, or the like.

In more embodiments, the host devices 108A and 108B may be configured to connect to the overlay layer of the communication network 100. In still more embodiments, the host devices 108A and 108B may connect to the overlay layer in such a manner that a multi-homing feature is enabled in the communication network 100. For example, each of the host devices 108A and 108B may be connected (or multi-homed) to a multi-homing set including at least two network devices of the network devices 106A-N. In the embodiments shown in FIG. 1, each of the host devices 108A and 108B may be multi-homed to a multi-homing set including all the network devices 106A-N. In still yet more embodiments, each of the host devices 108A and 108B may be multi-homed to the multi-homing set via a set of pseudo-wires (e.g., a set of Ethernet Segments “ESs”). For example, the host device 108A may be multi-homed to the multi-homing set via a first set of ESs, and the host device 108B may be multi-homed to the multi-homing set via a second set of ESs. In yet more embodiments, each of the first set of ESs and the second set of ESs may be provided with an Ethernet Segment Identifier (ESI) to uniquely identify a corresponding set of ESs in the communication network 100. For example, the first set of ESs may be provided with a first ESI (denoted as “ESI-1” in FIG. 1) and the second set of ESs may be provided with a second ESI (denoted as “ESI-2” in FIG. 1).

When a host device (e.g., the host device 108A or the host device 108B) is multi-homed, the host device may operate in one of an all-active redundancy mode or a single-active redundancy mode. In the all-active redundancy mode, all network devices in the multi-homing set are allowed to forward traffic to/from the host device. In the single-active redundancy mode, a single network device in the multi-homing set is allowed to forward traffic to/from the host device. The host device 108A or the host device 108B may be multi-homed to provide additional redundancy (such as the connection to at least two network devices) for tolerating network failures. The host devices 108A and 108B and the host networks 110A and 110B may form an underlay or physical layer of the communication network 100. As used herein, the physical layer (or the underlay layer) may correspond to a physical network infrastructure layer that includes various hardware components (such as the host devices 108A and 108B) and physical connections for ensuring reliable and efficient movement of data across the communication network 100.

In further embodiments, the communication network 100 may include at least one multicast source and at least one multicast destination. In the embodiments shown in FIG. 1, the communication network 100 may include a multicast destination 112A and a multicast source 112B. The multicast destination 112A and the multicast source 112B may be associated with (or connected to) the host networks 110A and 110B, respectively. The multicast destination 112A and the multicast source 112B may also be a part of the physical layer of the communication network 100. As used herein, the multicast source 112B may be a device (or an application) that transmits a multicast traffic flow to a multicast destination group including at least one multicast destination. The non-limiting examples of the multicast source 112B may include a multicast router, a multicast switch, or a multicast server such as a video streaming server, an Internet Protocol Television (IPTV) server, an online gaming server, a stock market data feed, a Voice over IP (VoIP) conferencing server, a software update server, or the like. As used herein, the multicast destination 112A may be a device (or an application) that subscribes to a specific multicast destination group and receives the multicast traffic flow transmitted to the specific multicast destination group. The non-limiting examples of the multicast destination 112A may include IPTV set-top boxes, corporate video conferencing systems, financial trading terminals, multiplayer online game clients, VoIP Phones, IoT devices, or the like. As used herein, the multicast traffic flow may correspond to a Broadcast, Unknown-unicast, and Multicast (BUM) traffic flow that is transmitted from one or more multicast sources to multiple multicast destinations. In still further embodiments, the multicast traffic flow may be designated with a unique combination of a particular multicast destination group and a particular multicast source for the multicast destination group. For example, the multicast traffic flow may be designated with a (Source, Group), i.e., (S, G), label to designate a multicast source of the multicast traffic flow and a multicast destination group to which the multicast traffic flow belongs.

In operation, to transmit the multicast traffic flow to the multicast destination group, the multicast source 112B may be configured to execute a multicast management protocol. For example, the multicast management protocol may correspond to an Internet Group Management Protocol (IGMP), a Multicast Listener Discovery (MLD), a Protocol Independent Multicast (PIM), a Source-Specific Multicast (SSM), or the like. Upon the execution of the multicast management protocol, the multicast source 112B may be configured to periodically transmit a multicast query message 114 (denoted as “QM” in FIG. 1) to the host device 108B via the host network 110B. For example, the multicast query message 114 may correspond to an IGMP query message, a PIM hello message, or the like. In still yet further embodiments, the multicast query message 114 may be transmitted from the multicast source 112B in anticipation that a multicast join message 116 (denoted as “JM” in FIG. 1) will be received for the multicast query message 114 to transmit the multicast traffic flow. Thereby, the multicast source 112B may ensure that the multicast traffic flow is transmitted only to intended multicast destinations that transmit such multicast join message 116. The multicast join message 116 may be a request for a subscription with the multicast source 112B. For example, the multicast join message 116 may correspond to an IGMP membership request message, a PIM join request message, or the like. Additionally, the multicast management protocol may include a multicast snooping feature to efficiently manage and control the multicast traffic flow in the communication network 100. The multicast snooping feature can be executed on the network devices 106A-N for snooping the multicast join message 116 received at its peer network devices. For example, the multicast snooping feature may correspond to an IGMP snooping feature of the IGMP.

Upon receiving the multicast query message 114 at the host device 108B, the host device 108B may execute a load balancing algorithm (for example, a hashing algorithm or function) to transmit the multicast query message 114 to one of the network devices 106A-N. For example, the load balancing algorithm may correspond to a hash-based equal-cost multi-path (ECMP) algorithm, a consistent hashing algorithm, a highest random weight (HRW) hashing algorithm, a modulo hashing algorithm, or the like. For example, as illustrated in FIG. 1, the host device 108B may hash the multicast query message 114 to the network device 106A. Once the multicast query message 114 is hashed to the network device 106A, the network device 106A may receive the multicast query message 114 and mark a port at which the multicast query message 114 is received as a Multicast router (Mrouter) port. As used herein, the Mrouter port may correspond to a network port of a network device that is designated to interface with one or more multicast sources. When a port is marked as the Mrouter port, the Mrouter port is expected to handle communication of control packets to/from the one or more multicast sources. For example, the Mrouter port is expected to handle the reception of query messages (such as the multicast query message 114) and the transmission of request messages (such as the multicast join message 116) from/to the one or more multicast sources.

When the multicast destination 112A is triggered to subscribe to the multicast source 112B, the multicast destination 112A may be configured to generate the multicast join message 116 and transmit the multicast join message 116 to the host device 108A via the host network 110A. For example, a trigger for the multicast destination 112A may be a user input indicating a request for the subscription with the multicast source 112B. Upon receiving the multicast join message 116 at the host device 108A, the host device 108A may be configured to execute a load balancing algorithm to transmit the multicast join message 116 to one of the network devices 106A-N. For example, as illustrated in FIG. 1, the multicast join message 116 may be hashed to the network device 106A. When the multicast join message 116 is hashed to the network device 106A, the network device 106A may receive the multicast join message 116. Upon receiving the multicast join message 116, the network device 106A may be configured to update a snooping table stored therein to include the multicast join message 116. The multicast join message 116 may include an address specifying a specific multicast destination group. The network device 106A may update the snooping table in such a manner that a port, from which the multicast join message 116 is received, is mapped to the address included in the multicast join message 116. Thereby, the multicast destination 112A may be added to the specific multicast destination group specified in the multicast join message 116.

Additionally, if the network devices 106A-N are enabled with the multicast snooping feature, the network device 106A may be configured to transmit a multicast join synch message 118 (denoted as “JSM” in FIG. 1) to synchronize its snooping table with one or more peer network devices. The multicast join synch message 118 may be transmitted from the network device 106A to the peer network devices that share the same ESI or the same EVI. For example, as illustrated in FIG. 1, the network device 106A may transmit the multicast join synch message 118 to the network devices 106B-N that share the same ESI. For example, the multicast join synch message 118 may correspond to an IGMP membership request synch message of the IGMP. Upon receiving the multicast join synch message 118, the network devices 106B-N may update their snooping tables to synchronize with the snooping table of the network device 106A.

Since the network device 106A is in the multi-homing feature-enabled EVPN 102, in a number of embodiments, the network device 106A may execute a Designated Forwarder (DF) election process to avoid redundant transmission of the multicast join message 116 to the multicast source 112B. This DF election process may be executed to designate one network device among the network devices 106A-N to transmit the multicast join message 116 to the multicast source 112B. If the network device 106A is designated as a DF for transmitting the multicast join message 116, the network device 106A may transmit, via the Mrouter port, the multicast join message 116 to the host device 108B. Upon receiving the multicast join message 116, the host device 108B may forward the multicast join message 116 to the multicast source 112B. Upon receiving the multicast join message 116 at the multicast source 112B, the multicast source 112B may transmit the multicast traffic flow to the multicast destination 112A via the host devices 108A and 108B and one or more network devices of the network devices 106A-N. Conversely if any other network device among the network devices 106B-N is designated as the DF, the designated network device may drop the multicast join message 116, instead of sending the multicast join message 116, since the designated network device has not marked its port as the Mrouter port. Further, since the network device 106A is designated as a non-DF, the network device 106A may also not forward the multicast join message 116 in anticipation that the DF would forward the multicast join message 116. As a result, the multicast join message 116 may not reach the multicast source 112B, leading to the multicast destination 112A failing to receive the multicast traffic flow. This can result in connection failures between the multicast destination 112A and the multicast source 112B even if the multicast destination 112A has requested to subscribe to the multicast source 112B.

To this end, in additional embodiments, the network devices 106A-N may comprise a port property synchronizing logic to manage the connections between the multicast destination 112A and the multicast source 112B in the multi-homing feature-enabled EVPN 102. This port property synchronizing logic may be configured to synchronize port properties of a network device having the Mrouter port with its peer network devices that share the same ESI or the same EVI. Specifically, the port properties of the network device are synchronized in such a manner that the port properties are consistent between the network device and its peer network devices. For example, the port property synchronizing logic may synchronize the port properties of the network device 106A with the peer network devices 106B-N in such a manner that the peer network devices 106B-N also mark their corresponding port directed to the multicast source 112B as the Mrouter port. Accordingly, when the network device 106A is designated as the non-DF, a DF designated among the peer network devices 106B-N may act as a proxy for the network device 106A to forward the multicast join message 116 towards the multicast source 112B. Thereby, the multicast source 112B may receive the multicast join message 116 and transmit the multicast traffic flow to the multicast destination 112A via the host devices 108A and 108B and the multi-homing feature-enabled EVPN 102. Accordingly, the connection failures between the multicast destination 112A and the multicast source 112B are suppressed.

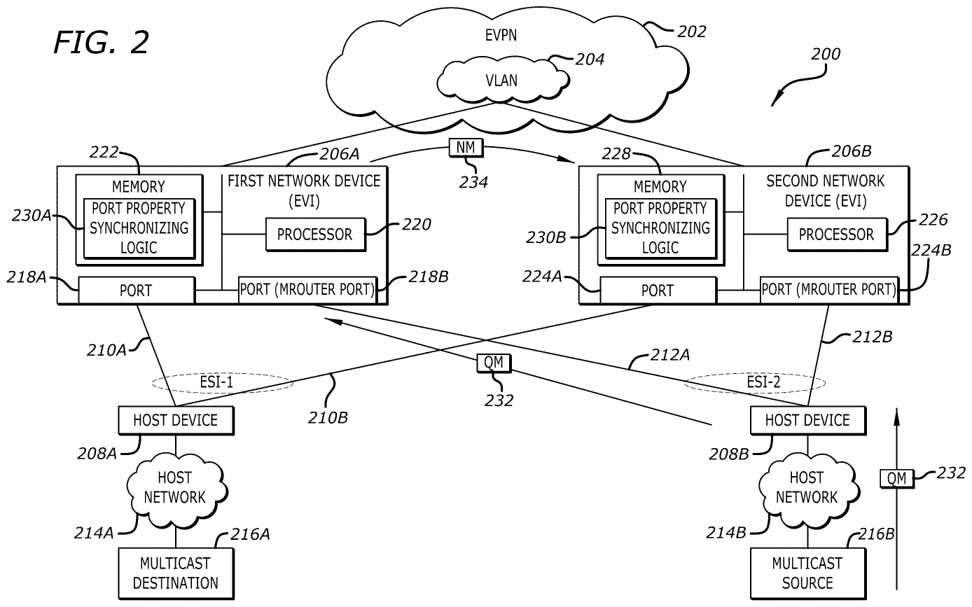

Although a specific embodiment of the communication network 100 for carrying out the various steps, processes, methods, and operations described herein is discussed with respect to FIG. 1, any of a variety of systems and/or processes may be utilized in accordance with embodiments of the disclosure. For example, the communication network 100 may include any finite number of host networks and any finite number of multicast destinations. Further, for example, a plurality of multicast destinations may be connected to a single host network. The elements depicted in FIG. 1 may also be interchangeable with other elements of FIGS. 2-9 as required to realize a particularly desired embodiment.

Referring to FIG. 2, a conceptual diagram of a communication network 200 for synchronizing port properties in accordance with various embodiments of the disclosure is shown. In the embodiments shown in FIG. 2, the communication network 200 may include an EVPN 202 that connects a plurality of host networks. In numerous embodiments, the EVPN 202 may include a first network device 206A and a second network device 206B. For example, the first network device 206A and the second network device 206B may correspond to routers, switches, provider edge devices, or the like. In numerous additional embodiments, the first network device 206A and the second network device 206B may be interconnected within the EVPN 202, for example, via a VLAN 204. In various embodiments, an Ethernet tag identifier may be provided for the VLAN 204 to uniquely identify the VLAN 204 in the EVPN 202. Specifically, the Ethernet tag identifier (denoted as “EVI” in FIG. 2) may be provided for the first network device 206A and the second network device 206B participating in the VLAN 204.

In many embodiments, the communication network 200 may further include host networks 214A and 214B. For example, the host networks 214A and 214B may correspond to LANs. In many additional embodiments, the host networks 214A and 214B may include host devices 208A and 208B, respectively. For example, the host devices 208A and 208B may correspond to routers, switches, customer edge devices, or the like.

In more embodiments, the host devices 208A and 208B may be configured to connect with the EVPN 202 via the first network device 206A and the second network device 206B, respectively. In still more embodiments, the host devices 208A and 208B may connect to the first network device 206A and the second network device 206B in such a manner that a multi-homing feature is enabled in the communication network 200. For example, each of the host devices 208A and 208B may be connected (or multi-homed) to a multi-homing set, for example, including the first network device 206A and the second network device 206B. In still yet more embodiments, the host devices 208A and 208B may be multi-homed to the first network device 206A and the second network device 206B via a set of ESs. In the embodiments shown in FIG. 2, the host device 208A may be multi-homed to the first network device 206A and the second network device 206B via a first set of ESs 210A and 210B, respectively. Similarly, the host device 208B may be multi-homed to the first network device 206A and the second network device 206B via a second set of ESs 212A and 212B, respectively. In some more embodiments, each of the first set of ESs 210A and 210B and the second set of ESs 212A and 212B may be provided with a unique ESI to identify a corresponding set of ESs in the communication network 200. For example, the first set of ESs 210A and 210B may be provided with a first ESI (denoted as “ESI-1” in FIG. 2), and the second set of ESs 212A and 212B may be provided with a second ESI (denoted as “ESI-2” in FIG. 2).

In further embodiments, the communication network 200 may include a multicast destination 216A and a multicast source 216B. The multicast destination 216A and the multicast source 216B may be connected to the host networks 214A and 214B, respectively. Specifically, the multicast destination 216A and the multicast source 216B may be connected to the host devices 208A and 208B via the host networks 214A and 214B, respectively. The multicast source 216B may be configured to transmit a multicast traffic flow to the multicast destination 216A via the host devices 208A and 208B and at least one of the first network device 206A or the second network device 206B.

In a variety of embodiments, the first network device 206A may include a plurality of network components, where each of the plurality of network components may be communicatively coupled to each other via a communication bus. The plurality of network components may include ports 218A and 218B, a processor 220, and a memory 222. Similarly, the second network device 206B may also include a plurality of network components including ports 224A and 224B, a processor 226, and a memory 228. As used herein, the ports 218A, 218B, 224A, and 224B may correspond to physical or virtual interfaces that connect the first network device 206A and the second network device 206B with other entities. For example, the physical or virtual interfaces may include an Ethernet interface, a Wi-Fi interface, a fiber optic interface, a cellular interface, a Transmission Control Protocol (TCP) interface, a User Datagram Protocol (UDP) interface, or the like. The ports 218A, 218B, 224A, and 224B may be configured to connect to the logical layer of the communication network 200. Specifically, the ports 218A, 218B, 224A, and 224B may be configured to connect to the host devices 208A and 208B. In the embodiments shown in FIG. 2, the ports 218A and 224A may be configured to connect to the host device 208A via the first set of ESs 210A and 210B, respectively. Likewise, the ports 218B and 224B may be configured to connect to the host device 208B via the second set of ESs 212A and 212B, respectively.

The processors 220 and 226 may include suitable logic, circuitry, and interfaces that are configured to execute instructions stored in the memories 222 and 228, respectively. The processors 220 and 226 may correspond to Application-Specific Integrated Circuit (ASIC) processors, Complex Instruction Set Computing (CISC) processors, Central Processing Units (CPUs), Explicitly Parallel Instruction Computing (EPIC) processors, Very Long Instruction Word (VLIW) processors, or other processors or circuits. The memories 222 and 228 may include suitable logic, circuitry, and interfaces that are configured to store a machine code or the instructions executable by the processors 220 and 226, respectively. The memories 222 and 228 may correspond to Random Access Memories (RAMs), Read Only Memories (ROMs), Electrically Erasable Programmable Read-Only Memories (EEPROMs), Hard Disk Drives (HDDs), Solid-State Drives (SSDs), or Secure Digital (SD) cards.

In a number of embodiments, the memories 222 and 228 may include a port property synchronizing logic 230A and a port property synchronizing logic 230B, respectively. Each port property synchronizing logic 230A and 230B may be a set of instructions stored in the corresponding memories 222 and 228 that, when executed by the respective processors 220 and 226, cause the processors 220 and 226 to carry out various port property synchronizing operations disclosed herein. Each port property synchronizing logic 230A and 230B may be configured to synchronize port properties between the first network device 206A and the second network device 206B upon receiving a multicast query message at one of the first network device 206A or the second network device 206B.

In operation, the multicast source 216B may be configured to execute a multicast management protocol such as an IGMP, an MLD protocol, a PIM, an SSM, or the like. Upon the execution of the multicast management protocol, the multicast source 216B may be configured to transmit, at regular or random time intervals, a multicast query message 232 (denoted as “QM” in FIG. 2) to the host device 208B via the host network 214B. Upon receiving the multicast query message 232 at the host device 208B, the host device 208B may be configured to execute a load balancing algorithm, for example, a hashing algorithm to hash the multicast query message 232 to one of the ESs 212A or 212B.

In the embodiments shown in FIG. 2, the multicast query message 232 is hashed to the ES 212A. When the multicast query message 232 is hashed to the ES 212A, the port property synchronizing logic 230A may be configured to receive, via the port 218B, the multicast query message 232 from the host device 208B. For example, the multicast query message 232 may correspond to an IGMP query message, a PIM hello message, or the like. In an example, the multicast query message 232 may be a request to identify whether a specific multicast destination group is active. The multicast query message 232 may include a source address indicating the multicast source 216B, a multicast destination group address indicating the specific multicast destination group, a type information indicating a type of query message, a timeout parameter indicating a time interval within which a response to the multicast query message 232 is expected, or the like.

In additional embodiments, upon receiving the multicast query message 232 at the port 218B, the port property synchronizing logic 230A may be configured to update at least one port property of the port 218B. As used herein, a port property of a port may refer to a specific configuration or attribute assigned to the port, which determines port behavior or capabilities within the communication network 200. For example, port properties of the port 218B may include an Mrouter port property, a security property, an Access Control List (ACL) property, an operation state property, or the like. In an example, the Mrouter port property may configure the port 218B as either an Mrouter port or a non-Mrouter port. The security property may configure the port 218B to either allow or restrict traffic to/from a specific MAC/IP address. The ACL property may be associated with a list of access controls for allowing a flow of traffic to/from a particular ES. The operation state property may indicate an operation state of the port 218B as one of an active state or inactive state.

In order to update the at least one port property of the port 218B, upon receiving the multicast query message 232 at the port 218B, the port property synchronizing logic 230A may update the Mrouter port property of the port 218B to configure the port 218B as the Mrouter port. As used herein, the Mrouter port may correspond to a network port of a network device that is designated to interface with one or more multicast sources. Additionally, or alternatively, the port property synchronizing logic 230A may update the security property of the port 218B to configure the port 218B for allowing the reception of the multicast traffic flow from the multicast source 216B or the host device 208B. Additionally, or alternatively, the port property synchronizing logic 230A may update the ACL property of the port 218B to adjust the list of access controls of the port 218B for allowing the multicast traffic flow to be received from the ES 212A. Additionally, or alternatively, the port property synchronizing logic 230A may update the operation state property of the port 218B to indicate the operation state of the port 218B as the active state.

In still additional embodiments, the port property synchronizing logic 230A may be configured to receive a user input specifying a port property of the port 218B to be updated. For example, the port property synchronizing logic 230A may receive a user input indicating that the port 218B is to be updated as the Mrouter port. Upon receiving the user input, the port property synchronizing logic 230A may be configured to update the Mrouter port property of the port 218B to configure the port 218B as the Mrouter port statically.

In still yet additional embodiments, when a subsequent multicast query message is not received within a specific time after the reception of the multicast query message 232, the port property synchronizing logic 230A may be further configured to update the at least one port property of the port properties of the port 218B. For example, the port property synchronizing logic 230A may update the Mrouter port property of the port 218B to configure the port 218B as the non-Mrouter port if the subsequent multicast query message is not received within the specific time. In an example, the specific time may be equal to or greater than the time interval indicated by the timeout parameter. Additionally, or alternatively, the port property synchronizing logic 230A may update the security property of the port 218B to configure the port 218B to restrict the reception of the multicast traffic flow from the multicast source 216B. Additionally, or alternatively, the port property synchronizing logic 230A may update the ACL property of the port 218B to adjust the list of access controls for restricting the reception of the multicast traffic flow from the ES 212A.

Various embodiments are based on a requirement that the updated at least one port property of the first network device 206A is to be synchronized with its peer network devices that share the same ESI (or the same EVI) for managing the multicast traffic flow between the multicast destination 216A and the multicast source 216B. To this end, in several embodiments, the port property synchronizing logic 230A may be configured to generate a notification message 234 (denoted as “NM” in FIG. 2) for synchronizing the updated at least one port property of the first network device 206A with the second network device 206B. The notification message 234 may include the updated at least one port property of the port 218B, an ESI on which the multicast query message 232 was received (e.g., the ESI of the ES 212A), or an EVI identifier on which the multicast query message 232 was received (e.g., the EVI identifier associated with the VLAN 204 or the first network device 206A). The updated at least one port property may correspond to at least one of the updated Mrouter port property, the updated security property, the updated ACL property, or the like. The updated Mrouter port property may indicate that the port 218B is updated as either the Mrouter port or the non-Mrouter port. The updated security property may indicate the port 218B is either allowed/restricted to receive the multicast traffic flow from the multicast source 216B. The updated ACL property may indicate the updated list of access controls.

In several more embodiments, the port property synchronizing logic 230A may be configured to transmit the notification message 234 to the second network device 206B. For example, the notification message 234 may be transmitted from the first network device 206A to the second network device 206B via the VLAN 204 or the EVPN 202. The notification message 234 may configure the second network device 206B to synchronize at least one port property of its one or more ports with the updated at least one port property.

In many further embodiments, the second network device 206B may receive the notification message 234. Specifically, the port property synchronizing logic 230B may receive the notification message 234 from the first network device 206A. Upon receiving the notification message 234, the port property synchronizing logic 230B may be configured to identify a port among the ports 224A and 224B and synchronize the updated at least one port property included in the notification message 234 with the identified port. This identification process may be performed based on the notification message 234. For example, the port associated with an ES having the ESI included in the notification message 234 can be identified. In an example, the port property synchronizing logic 230B may identify the port 224B that is associated with “ESI-2” included in the notification message 234.

In still further embodiments, upon identifying the port 224B, the port property synchronizing logic 230B may be configured to associate the port 224B with the updated at least one port property included in the notification message 234. Specifically, the port property synchronizing logic 230B may be configured to update at least one port property of the port 224B based on the updated at least one port property included in the notification message 234. For example, if the updated at least one port property corresponds to the updated Mrouter port property and the updated Mrouter port property indicates the port 218B as the Mrouter port, the port property synchronizing logic 230B may mark (or configure) the port 224B as the Mrouter port. Conversely, if the updated Mrouter port property indicates the port 218B as the non-Mrouter port, the port property synchronizing logic 230B may mark (or configure) the port 224B as the non-Mrouter port. Similarly, if the updated at least one port property corresponds to the updated security property or the updated ACL property, the port property synchronizing logic 230B may update a security property or an ACL property of the port 224B based on the updated security property or the updated ACL property, respectively.

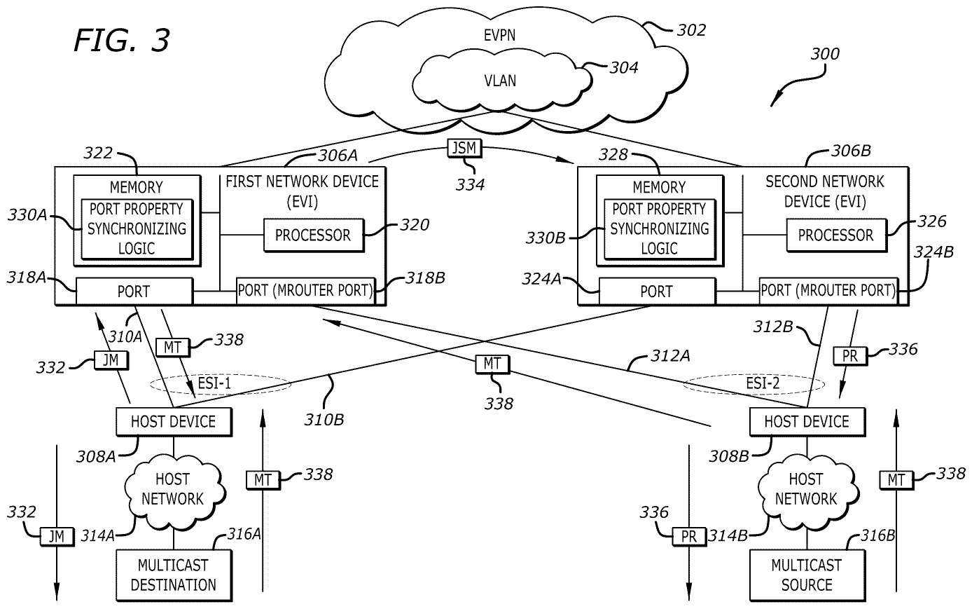

Thus, the at least one port property of the port 224B may be synchronized with the at least one port property of the port 218B. Consequently, the port properties may be made consistent between the first network device 206A and the second network device 206B. Accordingly, when the first network device 206A is elected as a non-DF and the second network device 206B is elected as a DF, the second network device 206B may act as a proxy for the first network device 206A to transmit a multicast join message received at the first network device 206A. Therefore, the multicast join message may reach the multicast source 216B. Thus, leading to the suppression of the connection failures between the multicast destination 216A and the multicast source 216B. Further, a multicast traffic flow transmission, between a multicast source and a multicast destination, based on synchronized port properties is described in conjunction with FIG. 3.

Though the first network device 206A and the second network device 206B are shown to be interconnected within the EVPN 202 via the VLAN 204, the scope of the disclosure is not limited to it. In various additional embodiments, the first network device 206A and the second network device 206B may be communicatively coupled via Virtual Extensible LAN (VXLAN), Segment Routing, or other solutions in the EVPN framework.

Although a specific embodiment of the communication network 200 for carrying out the various steps, processes, methods, and operations described herein is discussed with respect to FIG. 2, any of a variety of systems and/or processes may be utilized in accordance with embodiments of the disclosure. For example, if the second network device 206B receives the multicast query message 232, the first network device 206A may be configured to receive, from the second network device 206B, the notification message 234 to synchronize its port properties with the second network device 206B. Further, for example, the multicast destination 216A and the multicast source 216B may be connected to a single host network. The elements depicted in FIG. 2 may also be interchangeable with other elements of FIGS. 1 and 3-9 as required to realize a particularly desired embodiment.

Referring to FIG. 3, a conceptual diagram of a communication network 300 for a multicast traffic flow transmission in accordance with various embodiments of the disclosure is shown. In the embodiments shown in FIG. 3, the communication network 300 may include an EVPN 302, a VLAN 304, a multicast traffic flow 338, a second network device 306B, host devices 308A and 308B, ESs 310A, 310B, 312A, and 312B, host networks 314A and 314B, a multicast destination 316A, and a multicast source 316B.

The first network device 306A may include ports 318A and 318B, a processor 320, and a memory 322. Similarly, the second network device 306B may include ports 324A and 324B, a processor 326, and a memory 328. In numerous embodiments, the memories 322 and 328 may be configured to store a port property synchronizing logic 330A and a port property synchronizing logic 330B, respectively. Each port property synchronizing logic 330A and 330B may be configured to synchronize port properties between the first network device 306A and the second network device 306B. Specifically, each port property synchronizing logic 330A and 330B may synchronize the port properties of the ports 318B and 324B upon receiving a multicast query message at any of the ports 318B and 324B. For example, the multicast query message may be an IGMP query message, a PIM hello message, or the like. The port properties of the ports 318B and 324B may include an Mrouter port property, a security property, or an ACL property. In an example, the Mrouter port property may configure the ports 318B and 324B as either Mrouter ports or non-Mrouter ports. The security property may configure the ports 318B and 324B to either allow or restrict traffic to/from a specific MAC/IP address. The ACL property may be associated with a list of access controls for allowing a flow of traffic to/from a particular ES. In numerous additional embodiments, upon receiving the multicast query message at the port 318B, the port property synchronizing logic 330A may be configured to update the Mrouter port property of the port 318B in such a manner that the port 318B is configured as the Mrouter port. Further, the port property synchronizing logic 330A may be configured to synchronize the Mrouter port property of the port 318B with the port 324B of the second network device 306B. Thus, the port 324B may also be configured as the Mrouter port as shown in FIG. 3.

In operation, when the multicast destination 316A is triggered to subscribe to the multicast source 316B, the multicast destination 316A may be configured to generate a multicast join message 332 (denoted as “JM” as FIG. 3). In several embodiments, a trigger for the multicast destination 316A may include a user input indicating a request for the subscription with the multicast source 316B. In several more embodiments, the multicast join message 332 may include a source address indicating the multicast source 316B or a multicast destination group address indicating a specific multicast destination group which the multicast destination 316A wants to join. For example, the multicast join message 332 may correspond to an IGMP membership request message, a PIM join request message, or the like.

In many embodiments, upon generating the multicast join message 332, the multicast destination 316A may be configured to transmit the multicast join message 332 to the host device 308A via the host network 314A. In many further embodiments, upon receiving the multicast join message 332 at the host device 308A, the host device 308A may be configured to execute a load balancing algorithm, for example, a hashing algorithm, to hash the multicast join message 332 to one of the ESs 310A or 310B. In the embodiments shown in FIG. 3, the multicast join message 332 is hashed to the ES 310A. When the multicast join message 332 is hashed to the ES 310A, the first network device 306A may receive the multicast join message 332. Specifically, the port property synchronizing logic 330A may be configured to receive the multicast join message 332 via the port 318A. Upon receiving the multicast join message 332, the port property synchronizing logic 330A may be configured to update a snooping table stored in the memory 322 of the first network device 306A. In an example, the snooping table may be updated in such a manner that the port 318A is mapped to the multicast destination group address included in the multicast join message 332. Accordingly, when multicast traffic is received for the multicast destination group, the multicast traffic may be transmitted to the multicast destination 316A through the port 318A via the host device 308A. As used herein, the snooping table may be a data structure that stores multicast source addresses, multicast destination group addresses, or information about one or more ports. The information about the one or more ports may include mappings of the one or more ports to MAC addresses, IP addresses, or the multicast destination group addresses. Additionally, the information about the one or more ports may include port properties of the one or more ports. As used herein, the port properties may correspond to port configurations or port attributes assigned to the one or more ports.

In order to ensure that the peer network devices (such as the first network device 306A and the second network device 306B) have a consistent view of the MAC addresses, IP routes, or ESs, in more embodiments, the port property synchronizing logic 330A may be further configured to execute an EVPN route synchronization algorithm. In an example, the EVPN route synchronization algorithm may synchronize the snooping table of the first network device 306A with the second network device 306B using a Border Gateway Protocol (BGP). In still more embodiments, upon the execution of the EVPN route synchronization algorithm, the port property synchronizing logic 330A may be further configured to generate a multicast join synch message 334 (denoted as “JSM” in FIG. 3). The multicast join synch message 334 may include an ESI on which the multicast join message 332 was received (e.g., the ESI of the ES 310A), an EVI on which the multicast join message 332 was received (e.g., the EVI identifier associated with the VLAN 304 or the first network device 306A), or the source and multicast destination group addresses included in the multicast join message 332. For example, the multicast join synch message 334 may correspond to an IGMP membership request synch message of the IGMP. Upon generating the multicast join synch message 334, the port property synchronizing logic 330A may be further configured to transmit the multicast join synch message 334 to the second network device 306B via the VLAN 304 or the EVPN 302.

In various embodiments, upon receiving the multicast join synch message 334, the second network device 306B may be configured to update a snooping table stored in the memory 328 to synchronize with the snooping table of the first network device 306A. Specifically, the port property synchronizing logic 330B may be further configured to update the snooping table of the second network device 306B based on the multicast join synch message 334. In an example, the port property synchronizing logic 330B may update the snooping table of the second network device 306B to include the multicast join synch message 334. For example, the snooping table may be updated to include the source and multicast destination group addresses specified by the multicast join synch message 334. Additionally, the port property synchronizing logic 330B may update the snooping table of the second network device 306B to map the multicast destination group address to a port that has the ESI included in the multicast join synch message 334 (e.g., the port 324A).

Various embodiments are based on a recognition that the EVPN 302 may perform a redundant transmission of the multicast join message 332 to the multicast source 316B due to its multi-homing feature. To this end, in a variety of embodiments, the port property synchronizing logic 330A and/or the port property synchronizing logic 330B may be configured to execute a Designated Forwarder (DF) election process to avoid the redundant transmission of the multicast join message 332. This DF election process may be executed to designate one of the first network device 306A or the second network device 306B to transmit the multicast join message 332 to the multicast source 316B. If the first network device 306A is designated as a DF for transmitting the multicast join message 332, the port property synchronizing logic 330A may determine a port (e.g., the port 318B) that is designated as the Mrouter port for the multicast source 316B and transmit, via the Mrouter port, the multicast join message 332 to the host device 308B. Upon receiving the multicast join message 332 at the host device 308B, the host device 308B may forward the multicast join message 332 to the multicast source 316B. Conversely, if the second network device 306B is designated as the DF, the port property synchronizing logic 330A may determine a state of the Mrouter port as a non-DF state and may drop the multicast join message 332.

In further embodiments, if the second network device 306B is designated as the DF, the port property synchronizing logic 330B may be configured to determine, using the snooping table, a port (e.g., the port 324B) that is designated as the Mrouter port for the multicast source 316B and determine a state of the Mrouter port of the second network device 306B as a DF state. Further, the port property synchronizing logic 330B of the second network device 306B may be configured to generate a proxy report 336 (denoted as “PR” in FIG. 3) for the multicast source 316B. In still further embodiments, the proxy report 336 may be generated based on the multicast join synch message 334. For example, the proxy report 336 may include data elements similar to the multicast join message 332. In an example, the proxy report 336 may include the source and multicast destination group addresses included in the multicast join synch message 334 or information indicating that the multicast destination group address has requested to receive the multicast traffic. Upon generating the proxy report 336, the port property synchronizing logic 330B of the second network device 306B may be configured to transmit the proxy report 336 to the host device 308B via the Mrouter port (i.e., the port 324B). Upon receiving the proxy report 336 at the host device 308B, the host device 308B may be configured to forward the proxy report 336 to the multicast source 316B via the host network 314B.

In additional embodiments, upon receiving the proxy report 336, the multicast source 316B may be configured to transmit a multicast traffic flow 338 (denoted as “MT” in FIG. 3) to the host device 308B via the host network 314B. As used herein, the multicast traffic flow 338 may correspond to a BUM traffic flow. The multicast traffic flow 338 may be designated with a unique combination of a particular multicast destination group and a particular multicast source for the multicast destination group. For example, the multicast traffic flow may be designated with the source address of the multicast source 316B and the multicast destination group address included in the proxy report 336.

Upon receiving the multicast traffic flow 338 at the host device 308B, the host device 308B may execute the hashing algorithm to hash the multicast traffic flow 338 to one of the ESs 312A or 312B. In the embodiments shown in FIG. 3, the multicast traffic flow 338 is hashed to the ES 312A. When the multicast traffic flow 338 is hashed to the ES 312A, the first network device 306A may receive the multicast traffic flow 338. Specifically, the port property synchronizing logic 330A of the first network device 306A may be configured to receive the multicast traffic flow 338 via the Mrouter port (i.e., the port 318B). Further, the port property synchronizing logic 330A of the first network device 306A may be configured to transmit, based on the snooping table associated with the first network device 306A, the multicast traffic flow 338 to the host device 308A via the port 318A mapped to the multicast destination group address indicated by the multicast traffic flow 338. Upon receiving the multicast traffic flow 338 at the host device 308B, the host device 308B may forward the multicast traffic flow 338 to the multicast destination 316A via the host network 314A.

In this way, the second network device 306B may act as a proxy for the first network device 306A to forward the proxy report 336, indicating the multicast join message 332, towards the multicast source 316B. To this end, the multicast source 316B may receive the multicast join message 332 and transmit the multicast traffic flow 338 to the multicast destination 316A via the host devices 308A and 308B and the multi-homing feature-enabled EVPN 302. Thereby, leading to the suppression of the connection failures between the multicast destination 316A and the multicast source 316B.

Although a specific embodiment of the communication network 300 for carrying out the various steps, processes, methods, and operations described herein is discussed with respect to FIG. 3, any of a variety of systems and/or processes may be utilized in accordance with embodiments of the disclosure. For example, each port property synchronizing logic 330A and 330B may be embodied or included in the processors 320 and 326 or as a standalone component in the first network device 306A and the second network device 306B, respectively. The elements depicted in FIG. 3 may also be interchangeable with other elements of FIGS. 1-2 and 4-9 as required to realize a particularly desired embodiment.

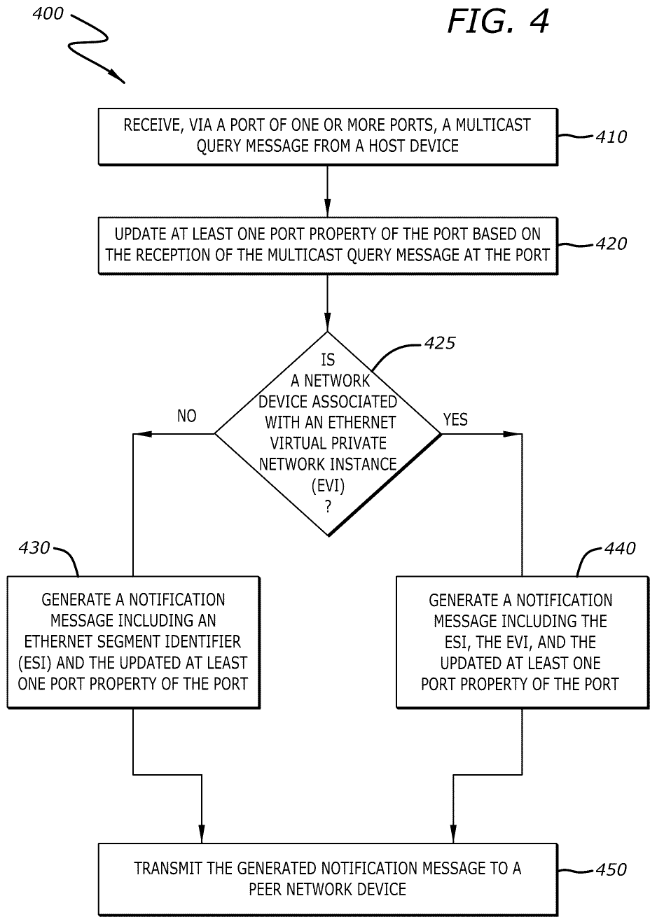

Referring to FIG. 4, a flowchart depicting a process 400 for transmitting a notification message to a peer network device in accordance with various embodiments of the disclosure is shown. In many embodiments, the process 400 may receive, via a port of one or more ports, a multicast query message from a host device (block 410). The host device may be associated with a multicast source that executes a multicast management protocol for forwarding the multicast query message. For example, the multicast management protocol may correspond to an IGMP, a MLD, a PIM, or the like. The host device may be coupled to a multi-homing set including a network device and the peer network device. Specifically, the host device may be coupled to the network device and the peer network device via a set of ESs. These ESs may be provided with an ESI to uniquely identify the set of ESs in a communication network. In many further embodiments, the network device and the peer network device may take part in an EVI associated with the communication network. As used herein, the EVI may correspond to an EVPN routing and forwarding instance that spans all network devices participating in that EVPN. In these embodiments, the network device and the peer network device may be provided with an EVI identifier to uniquely identify the network device and the peer network device participating in the EVI.

In many additional embodiments, the multicast query message may be received by the network device of the multi-homing set from the host device via its port among the one or more ports. For example, the multicast query message may correspond to an IGMP query message, a PIM hello message, or the like. In an example, the multicast query message may be a request to identify whether a specific multicast destination group is active. The multicast query message may include a source address indicating a multicast source, a multicast destination group address indicating the specific multicast destination group, a type information indicating a type of the multicast query message, a timeout parameter indicating a time interval within which a response for the multicast query message is expected, or the like.

In more embodiments, the process 400 may update at least one port property of the port based on the reception of the multicast query message at the port (block 420). For example, the at least one port property of the port may be updated by the network device. In some more embodiments, the reception of the multicast query message at the port may be an indication that the port is either directly or indirectly (i.e., via an intermediate entity) coupled to the multicast source. Accordingly, the reception of the multicast query message at the port may act as a trigger to update the at least one port property of the port. As used herein, the port property of the port may refer to a specific configuration or attribute assigned to the port, which determines its behavior or capabilities within the communication network. For example, the port property may correspond to at least one of an Mrouter port property, a security property, an ACL property, or the like. In an example, the Mrouter port property may configure the port as either an Mrouter port or a non-Mrouter port. The security property may configure the port to either allow or restrict traffic to/from a specific MAC/IP address. The ACL property may be associated with a list of access controls for allowing a flow of traffic to/from a particular ES.

In still more embodiments, to update the at least one port property of the port, the process 400 may update the Mrouter port property of the port to configure the port as the Mrouter port upon receiving the multicast query message at the port. As used herein, the Mrouter port may correspond to a network port of a network device that is designated to interface with one or more multicast sources. Additionally, or alternatively, the process 400 may update the security property of the port to configure the port to allow a reception of a multicast traffic flow from the multicast source. Additionally, or alternatively, the process 400 may update the ACL property of the port to adjust the list of access controls of the port for allowing the multicast traffic flow to be received from the ES connected to the port.

In further embodiments, the process 400 may determine whether the network device is associated with the EVI (block 425). Specifically, the process 400 may determine if the network device is connected to the peer network device via one or more broadcast domains (such as a VLAN). Additionally, the network device may be associated with an identifier database storing the EVI identifier associated with the network device. In this example, the process 400 may determine that the network device is associated with the EVI if the EVI identifier is present in the identifier database. Conversely, if the EVI identifier is absent in the identifier database, the process 400 may determine that the network device is not associated with the EVI.

In still further embodiments, if the network device is not associated with the EVI, the process 400 may generate the notification message including the ESI associated with the port and the updated at least one port property of the port (block 430). The ESI included in the notification message may indicate the ES, connected to the port, on which the multicast query message was received. The updated at least one port property may correspond to at least one of the updated Mrouter port property, the updated security property, or the updated ACL property. The updated Mrouter port property may indicate the port is configured as the Mrouter port. The updated security property may indicate the port is allowed to receive the multicast traffic flow from the multicast source. The updated ACL property may indicate the updated list of access controls for allowing the reception of the multicast traffic flow from the ES.

However, in still yet further embodiments, if the network device is associated with the EVI, the process 400 may generate the notification message including the ESI associated with the port, the EVI identifier, and the updated at least one port property of the port (block 440). The EVI identifier included in the notification message may indicate the EVI on which the multicast query message was received. The notification message including the ESI and the updated at least one port property or the notification message including the ESI, the EVI identifier, and the updated at least one port property may be generated by the network device.

In a variety of embodiments, the process 400 may transmit the generated notification message to the peer network device (block 450). For example, the generated notification message may be transmitted by the network device to its peer network device. In several embodiments, the notification message may configure the peer network device to synchronize at least one port property of its port with the updated at least one port property included in the notification message. Thus, the at least one port property may be made consistent between the network device and the peer network device, which in turn can enable the peer network device to act as a proxy for forwarding the response to the multicast query message if the network device fails. Thus, leading to the suppression of connection failures between the multicast destination group and the multicast source.

Although a specific embodiment for the process 400 for carrying out the various steps, processes, methods, and operations described herein is discussed with respect to FIG. 4, any of a variety of systems and/or processes may be utilized in accordance with embodiments of the disclosure. For example, when a subsequent multicast query message is not received within a specific time after the reception of the multicast query message, the process 400 may repeat the blocks 420-450 shown in FIG. 4. In this example, the process 400 may update the at least one port property of the port to its previous state when the subsequent multicast query message is not received within the specific time. In an example, the process 400 may update the Mrouter port property of the port to configure the port as the non-Mrouter port when the subsequent multicast query message is not received within the specific time. The specific time may be equal to or greater than the time interval indicated by the timeout parameter. The elements depicted in FIG. 4 may also be interchangeable with other elements of FIGS. 1-3 and 5-9 as required to realize a particularly desired embodiment.

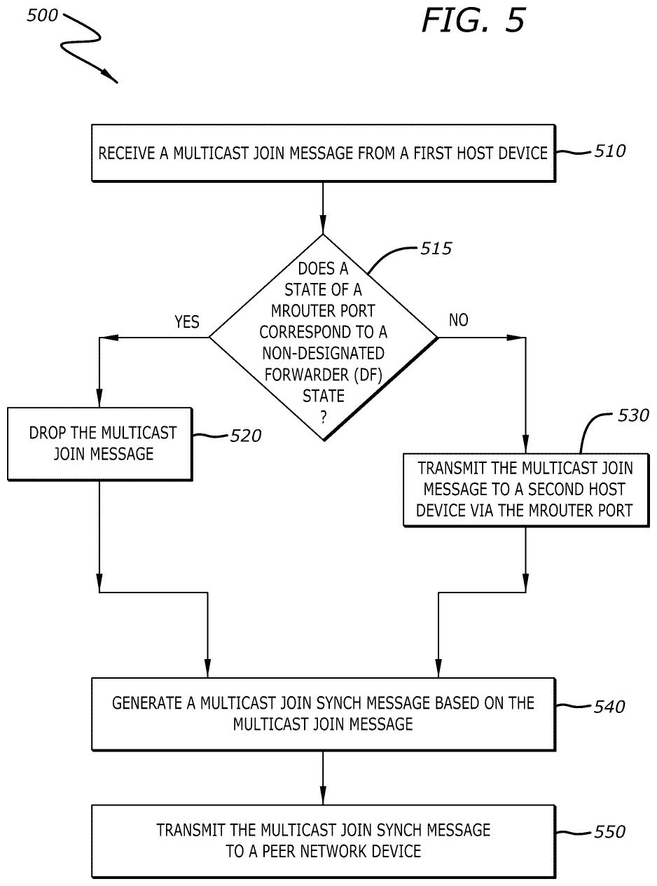

Referring to FIG. 5, a flowchart depicting a process 500 for transmitting a multicast join synch message to a peer network device in accordance with various embodiments of the disclosure is shown. In many embodiments, the process 500 may receive a multicast join message from a first host device (block 510). The first host device (e.g., a new host device) may be associated with a multicast destination. As used herein, the multicast destination may be a device (or an application) that subscribes to a specific multicast destination group and receives a multicast traffic flow transmitted to the specific multicast destination group. The multicast destination may forward, to the first host device, the multicast join message to subscribe to the specific multicast destination group. In many further embodiments, the first host device may be coupled to a multi-homing set including a network device and the peer network device. The first host device may forward the multicast join message to the network device of the multi-homing set.

In many additional embodiments, the multicast join message may be received by the network device. For example, the multicast join message may correspond to an IGMP membership request message, a PIM join request message, or the like. In an example, the multicast join message may include a source address indicating a multicast source or a multicast destination group address indicating the specific multicast destination group that the multicast destination has requested to join. As used herein, the multicast source may be a device (or an application) that transmits the multicast traffic flow to the specific multicast destination group. In several embodiments, the network device may include one or more ports. Upon receiving the multicast join message, the process 500 may update a snooping table of the network device in such a manner that the multicast destination group address is mapped to one of the one or more ports on which the multicast join message is received. As used herein, the snooping table may be a data structure that stores multicast source addresses, multicast destination group addresses, or information about the one or more ports. The information about the one or more ports may include mappings of the one or more ports to MAC addresses, IP addresses, or the multicast destination group addresses. In several more embodiments, the one or more ports may include an Mrouter port that is designated to interface with the multicast source.

In more embodiments, the process 500 may determine whether a state of the Mrouter port corresponds to a non-DF state (block 515). For example, the network device may determine if the state of the Mrouter port corresponds to the non-DF state. In still more embodiments, the process 500 may execute a DF election process to designate one of the network device or the peer network device as a DF for forwarding the multicast join message. If the network device is designated as the DF, the process 500 may determine that the state of the Mrouter port corresponds to a DF state. Conversely, if the peer network device is designated as the DF, the process 500 may determine that the state of the Mrouter port corresponds to the non-DF state.

In yet more embodiments, if the state of the Mrouter port corresponds to the non-DF state, the process 500 may drop the multicast join message (block 520). For example, the network device may discard the multicast join message instead of transmitting the multicast join message. In an example, the network device may not transmit the multicast join message in anticipation that the peer network device transmits the multicast join message. Thus, the process 500 may avoid redundant transmission of the multicast join message.

However, in still yet more embodiments, if the state of the Mrouter port does not correspond to the non-DF state, the process 500 may transmit the multicast join message to a second host device via the Mrouter port (block 530). For example, the multicast join message may be transmitted by the network device to the second host device via its Mrouter port. The second host device may also be coupled to the multi-homing set. Further, the second host device may be associated with the multicast source. Upon receiving the multicast join message at the second host device, the second host device may forward the multicast join message to the multicast source.

In a variety of embodiments, the process 500 may generate a multicast join synch message based on the multicast join message (block 540). For example, the multicast join synch message may be generated by the network device. The multicast join synch message may include an ESI on which the multicast join message is received, an EVI on which the multicast join message is received, or the source and multicast destination group addresses included in the multicast join message. For example, the multicast join synch message may correspond to an IGMP membership request synch message of the IGMP.

In numerous embodiments, the process 500 may transmit the multicast join synch message to the peer network device (block 550). For example, the multicast join synch message may be transmitted by the network device to its peer network device. In numerous additional embodiments, the multicast join synch message may be transmitted from the network device to its peer network device to synchronize the snooping table of the network device with its peer network device. Thereby, if the peer network device has an Mrouter port similar to the network device for the multicast source and the network device fails to transmit the multicast join message, the multicast join synch message may configure the peer network device to act as a proxy for transmitting the multicast join message to the multicast source. Thus, leading to the suppression of the connection failures between the multicast destination and the multicast source.

Although a specific embodiment for the process 500 for carrying out the various steps, processes, methods, and operations described herein is discussed with respect to FIG. 5, any of a variety of systems and/or processes may be utilized in accordance with embodiments of the disclosure. For example, the process 500 may receive a plurality of multicast join messages from a plurality of first host devices and forward/drop the plurality of multicast join messages to the second host device based on the state of the Mrouter port. The elements depicted in FIG. 5 may also be interchangeable with other elements of FIGS. 1-4 and 6-9 as required to realize a particularly desired embodiment.

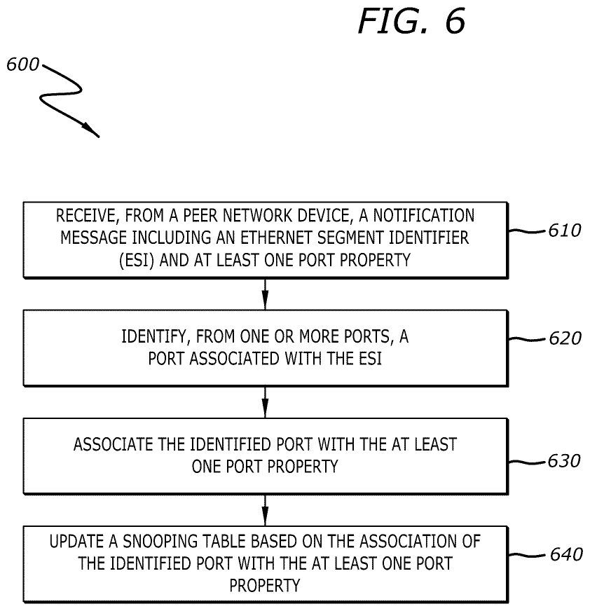

Referring to FIG. 6, a flowchart depicting a process 600 for updating a snooping table in accordance with various embodiments of the disclosure is shown. In many embodiments, the process 600 may receive, from a peer network device, a notification message including an ESI and at least one port property (block 610). For example, the notification message may be received by a network device from its peer network device. The network device and the peer network device may belong to a multi-homing set coupled to a host device. The ESI included in the notification message may indicate an ES on which a multicast query message was received from the host device. For example, the multicast query message may correspond to an IGMP query message, a PIM hello message, or the like. The at least one port property may correspond to at least one of an Mrouter port property, a security property, or an ACL property. The Mrouter port property may indicate a port of the peer network device is configured as either the Mrouter port or the non-Mrouter port. The security property may indicate the port of the peer network device is either allowed or restricted to receive a multicast traffic flow from a specific IP/MAC address. The ACL property may indicate a list of access controls either for allowing or restricting the multicast traffic flow from a particular ES. In many additional embodiments, the notification message may be received by the network device to synchronize at least one port property of its port with the at least one port property of the port of the peer network device.

In a variety of embodiments, the process 600 may identify, from the one or more ports, a port associated with the ESI (block 620). For example, the network device may identify, from its one or more ports, the port associated with the ESI. In an example, the network device may identify the port that is associated with an ES having the ESI included in the notification message.

In further embodiments, the process 600 may associate the identified port with the at least one port property (block 630). For example, the network device may associate the identified port with the at least one port property included in the notification message. In an example, if the at least one port property corresponds to the Mrouter port property and the Mrouter port property indicates the port of the peer network device is configured as the Mrouter port, the network device may also configure (or mark) the identified port as the Mrouter port. Conversely, if the Mrouter port property indicates the port of the peer network device is configured as the non-Mrouter port, the network device may also configure (or mark) the identified port as the non-Mrouter port. Similarly, when the at least one port property corresponds to the security property, or the ACL property, the network device may configure the security property, or ACL property of the identified port based on the at least one port property included in the notification message.

In more embodiments, the process 600 may update the snooping table based on the association of the identified port with the at least one port property (block 640). For example, the network device may update its snooping table based on the association of the identified port with the at least one port property. As used herein, the snooping table may be a data structure that stores multicast source addresses, multicast destination group addresses, or information about the one or more ports. The information about the one or more ports may include mappings of the one or more ports to MAC addresses, IP addresses, or the multicast destination group addresses. Additionally, the information about the one or more ports may include the port properties of the one or more ports. In still more embodiments, when the at least one port property of the identified port is changed, the network device may update its snooping table to indicate the changes made to the identified port. For example, when the identified port is changed as the Mrouter port, the network device may update its snooping table in such a manner that the Mrouter port property of the identified port indicates the identified port is configured as the Mrouter port. Similarly, when the security property, or ACL property of the identified port is changed, the network device may update its snooping table to indicate the changes made to the security property, or ACL property of the identified port.

Although a specific embodiment for the process 600 for carrying out the various steps, processes, methods, and operations described herein is discussed with respect to FIG. 6, any of a variety of systems and/or processes may be utilized in accordance with embodiments of the disclosure. For example, the network device and the peer network device may take part in an EVI. As used herein, the EVI may correspond to an EVPN routing and forwarding instance that spans all network devices participating in that EVPN. In this example, the received notification message may further include an EVI identifier indicating the EVI. The elements depicted in FIG. 6 may also be interchangeable with other elements of FIGS. 1-5 and 7-9 as required to realize a particularly desired embodiment.

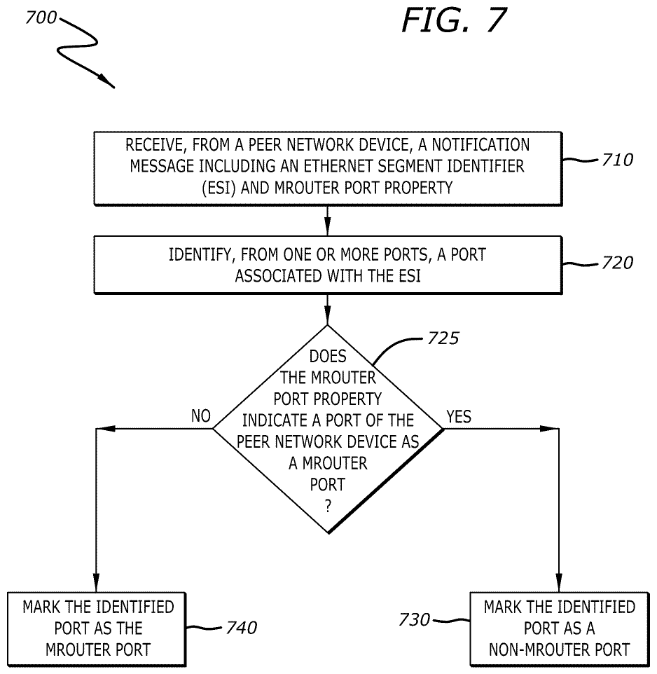

Referring to FIG. 7, a flowchart depicting a process 700 for marking a port either as an Mrouter port or a non-Mrouter port in accordance with various embodiments of the disclosure is shown. In many embodiments, the process 700 may receive, from a peer network device, a notification message including an ESI and an Mrouter port property (block 710). The ESI included in the notification message may indicate an ES on which a multicast query message was received from a host device. For example, the multicast query message may correspond to an IGMP query message, a PIM hello message, or the like. The host device may be coupled to a multi-homing set including a network device and the peer network device. In many further embodiments, the network device may receive the notification message including the ESI and the Mrouter port property. In many additional embodiments, the Mrouter port property may indicate a port of the peer network device is configured as either the Mrouter port or the non-Mrouter port.

In a variety of embodiments, the process 700 may identify, from one or more ports of the network device, a port associated with the ESI (block 720). For example, the port associated with the ESI may be identified by the network device from its one or more ports. In an example, the network device may identify the port that is associated with an ES having the ESI included in the notification message.

In further embodiments, the process 700 may determine if the Mrouter port property indicates the port of the peer network device as the Mrouter port (block 725). For example, the network device may determine if the Mrouter port property indicates the port of the peer network device as the Mrouter port. In still further embodiments, if the Mrouter port property indicates the port of the peer network device as a non-Mrouter port, the process 700 may mark the identified port as the non-Mrouter port (block 730). For example, the network device may update Mrouter port property of the identified port to configure (or designate) the identified port as the non-Mrouter port.

However, in still yet further embodiments, if the Mrouter port property indicates the port of the peer network device as the Mrouter port, the process 700 may mark the identified port as the Mrouter port (block 740). For example, the network device may update the Mrouter port property of the identified port to configure (or designate) the identified port as the Mrouter port. In an example, when the identified port is configured as the Mrouter port, the identified port can be expected to interface with a multicast source. As used herein, the multicast source may be a device (or an application) that transmits a multicast traffic flow to a specific multicast destination group.

Although a specific embodiment for the process 700 for carrying out the various steps, processes, methods, and operations described herein is discussed with respect to FIG. 7, any of a variety of systems and/or processes may be utilized in accordance with embodiments of the disclosure. For example, the process 700 may further update a snooping table associated with the network device to indicate the changes made to the Mrouter port property of the identified port. The elements depicted in FIG. 7 may also be interchangeable with other elements of FIGS. 1-6 and 8-9 as required to realize a particularly desired embodiment.

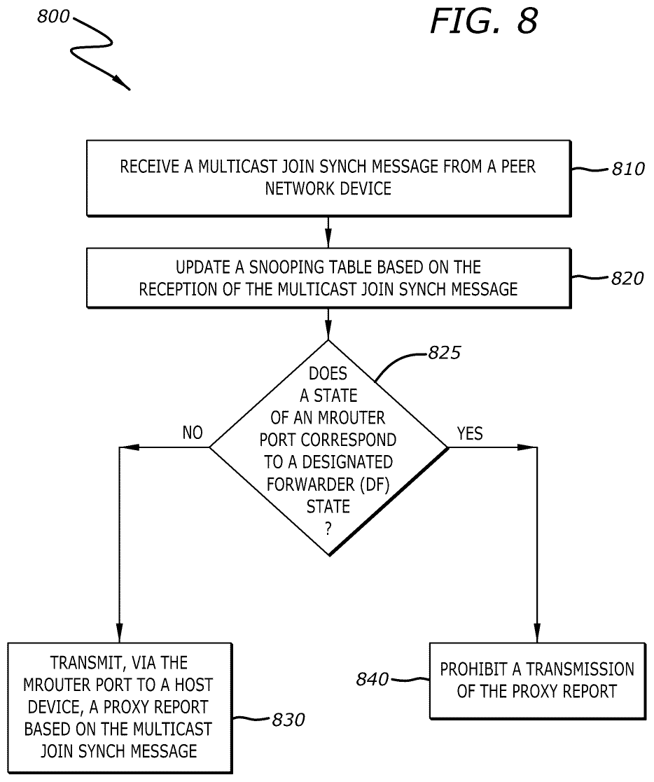

Referring to FIG. 8, a flowchart depicting a process 800 for transmitting a proxy report or prohibiting the transmission of the proxy report in accordance with various embodiments of the disclosure is shown. In many embodiments, the process 800 may receive a multicast join synch message from a peer network device (block 810). For example, a network device may receive the multicast join synch message from the peer network device. The network device and the peer network device may belong to a multi-homing set coupled to a host device. The peer network device may be triggered to transmit the multicast join synch message to the network device upon receiving a multicast join message from the host device. For example, the multicast join message may correspond to an IGMP membership request message or a PIM join request message.

In many further embodiments, the multicast join synch message may include an ESI on which the multicast join message was received, a source address indicating a multicast source, or a multicast destination group address indicating a specific multicast destination group that a multicast destination has requested to join. As used herein, the multicast destination may be a device (or an application) that subscribes to the specific multicast destination group and receives a multicast traffic flow transmitted for the specific multicast destination group. As used herein, the multicast source may be a device (or an application) that transmits the multicast traffic flow to the specific multicast destination group. In many additional embodiments, the network device may receive the multicast join synch message to synchronize its snooping table with a snooping table of the peer network device.

In more embodiments, the process 800 may update the snooping table of the network device based on the reception of the multicast join synch message (block 820). For example, the network device may update its snooping table based on the reception of the multicast join synch message. In still more embodiments, the network device may include one or more ports in which a port may correspond to an Mrouter port. As used herein, the Mrouter port may correspond to a network port of a network device that is designated to interface with the multicast source. As used herein, the snooping table may be a data structure that stores multicast source addresses, multicast destination group addresses, or information about the one or more ports. The information about the one or more ports may include mappings of the one or more ports to MAC addresses, IP addresses, or the multicast destination group addresses. Additionally, the information about the one or more ports may include port properties of the one or more ports. As used herein, the port properties may correspond to port configurations or port attributes assigned to the one or more ports.

In still yet more embodiments, the network device may update its snooping table to include the source and multicast destination group addresses included in the multicast join synch message. In order to update the information about the one or more ports, the network device may identify, from the one or more ports, a port that is associated with the ESI included in the multicast join synch message and map the identified port with the multicast destination group address included in the multicast join synch message. Further, the network device may update its snooping table to include the mapping of the identified port.

In further embodiments, the process 800 may determine whether a state of the Mrouter port corresponds to a DF state (block 825). For example, the network device may determine if the state of the Mrouter port corresponds to the DF state. In still further embodiments, the process 800 may execute a DF election process to designate one of the network device or the peer network device as a DF for forwarding the multicast join message. If the network device is designated as the DF, the process 800 may determine that the state of the Mrouter port corresponds to the DF state. Conversely, if the peer network device is designated as the DF, the process 800 may determine that the state of the Mrouter port corresponds to a non-DF state.

In numerous embodiments, if the state of the Mrouter port corresponds to the DF state, the process 800 may transmit, via the Mrouter port to a host device associated with the multicast source, a proxy report based on the multicast join synch message (block 830). For example, the proxy report may be transmitted by the network device to the host device associated with the multicast source via its Mrouter port. In an example, the proxy report may be transmitted by the network device on behalf of the peer network device that failed to transmit the multicast join message. In numerous additional embodiments, the proxy report may include data elements similar to the multicast join message. For example, the proxy report may include the source and multicast destination group addresses included in the multicast join synch message or information indicating that the multicast destination group address has requested to receive the multicast traffic flow.

However, if the state of the Mrouter port corresponds to the non-DF state, in several embodiments, the process 800 may prohibit the transmission of the proxy report (block 840). For example, the network device may prohibit the transmission of the proxy report to the host device associated with the multicast source. In an example, the transmission of the proxy report may be prohibited in anticipation that the peer network would transmit the multicast join message to the host device associated with the multicast source. Thus, the redundant transmission of the multicast join message to the host device associated with the multicast source is suppressed.

Although a specific embodiment for the process 800 for carrying out the various steps, processes, methods, and operations described herein is discussed with respect to FIG. 8, any of a variety of systems and/or processes may be utilized in accordance with embodiments of the disclosure. For example, the process 800 may further receive, based on the transmitted proxy report, the multicast traffic flow from the host device associated with the multicast source and forward the multicast traffic flow toward the multicast destination using the updated snooping table. The elements depicted in FIG. 8 may also be interchangeable with other elements of FIGS. 1-7 and 9 as required to realize a particularly desired embodiment.

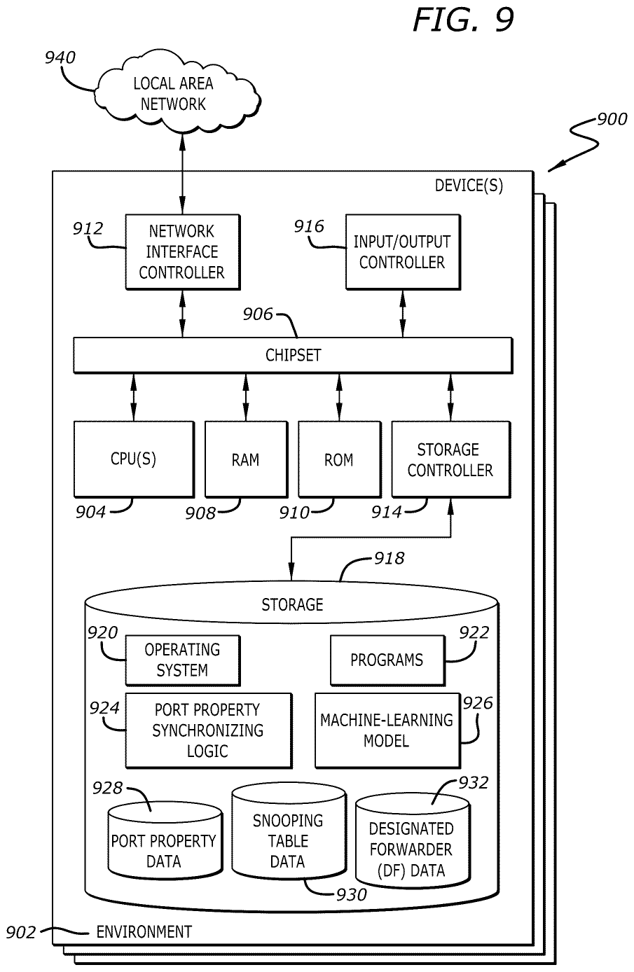

Referring to FIG. 9, a conceptual block diagram of a device 900 suitable for configuration with a port property synchronizing logic in accordance with various embodiments of the disclosure is shown. The embodiment of the conceptual block diagram depicted in FIG. 9 can illustrate a conventional server, computer, workstation, desktop computer, laptop, tablet, network appliance, e-reader, smartphone, or other computing device, and can be utilized to execute any of the application or logic components presented herein. The embodiment of the conceptual block diagram depicted in FIG. 9 can also illustrate an access point, a switch, or a router in accordance with various embodiments of the disclosure. The device 900 may, in many non-limiting examples, correspond to physical devices or to virtual resources described herein.

In many embodiments, the device 900 (e.g., a network device) may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, one or more processors 904 (hereinafter, referred to as “the processor(s) 904”), such as, but not limited to, central processing units (“CPUs”) can be configured to operate in conjunction with a chipset 906. The processor(s) 904 can be standard programmable CPUs that perform arithmetic and logical operations necessary for the operation of the device 900.

In a number of embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 906 may provide an interface between the processor(s) 904 and the remainder of the components and devices within the environment 902. The chipset 906 can provide an interface to a random-access memory (“RAM”) 908, which can be used as the main memory in the device 900 in some embodiments. The chipset 906 can further be configured to provide an interface to a computer-readable storage medium such as a read-only memory (“ROM”) 910 or non-volatile RAM (“NVRAM”) for storing basic routines that can help with various tasks such as, but not limited to, starting up the device 900 or transferring information between the various components and devices. The ROM 910 or NVRAM can also store other application components necessary for the operation of the device 900 in accordance with various embodiments described herein.

Additional embodiments of the device 900 can be configured to operate in a networked environment using logical connections to remote computing devices and computer systems through a network, such as the network 940. The chipset 906 can include functionality for providing network connectivity through a network interface card (“NIC”) 912, which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for instance, store an operating system 920, applications 922, port property data 928, snooping table data 930, and Designated Forwarder (DF) data 932 which are described in greater detail below. The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

In still more embodiments, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to device 900. Stated otherwise, some or all of the operations performed by the cloud computing network, and or any components included therein, may be performed by one or more devices 900 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CDROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store the operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In many additional embodiments, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as the applications 922 and transform the device 900 by specifying how the processor(s) 904 can transition between states, as described above. In some embodiments, the device 900 has access to computer-readable storage media storing computer-executable instructions which, when executed by the device 900, perform the various processes described above with regard to FIGS. 1-8. In certain embodiments, the device 900 can also include computer-readable storage media having instructions stored thereupon for performing any of the other computer-implemented operations described herein.

In many further embodiments, the device 900 may include a port property synchronizing logic 924. The port property synchronizing logic 924 can be configured to perform one or more of the various steps, processes, operations, or other methods that are described above. Often, the port property synchronizing logic 924 can be a set of instructions stored within a non-volatile memory that, when executed by the processor(s) 904 can carry out these steps, etc. In some embodiments, the port property synchronizing logic 924 may be a client application that resides on a network-connected device, such as, but not limited to, a server, switch, personal or mobile computing device in a single or distributed arrangement.

In numerous embodiments, if a port of the device 900 is coupled to a multicast source, the port property synchronizing logic 924 may be configured to update at least one port property of the port. For example, the at least one port property may correspond to an Mrouter port property that configures the port either as an Mrouter port or a non-Mrouter port. In an example, the Mrouter port property may be updated in a such manner that the port is configured as the Mrouter port. Further, the port property synchronizing logic 924 may be configured to synchronize the updated at least one port property with its peer network device by generating and forwarding a notification message including the updated at least one port property to the peer network device. Thus, the port property synchronizing logic 924 may ensure that the at least one port between the device 900 and its peer network devices is consistent. Accordingly, if the device 900 fails to transmit a multicast join message for a multicast query message in a multi-homing feature-enabled EVPN, the peer network device may be configured to act as a proxy for the device 900 to transmit the multicast join message which in turn enables managing of a multicast traffic flow between the multicast source and a multicast destination.

In numerous additional embodiments, the port property data 928 may correspond to one or more port properties of the port of the device 900. As used herein, the port properties may refer to specific configurations or attributes assigned to the port, which determine its behavior or capabilities within a communication network. For example, the port properties of the port may include the Mrouter port property, a security property, an ACL property, an operation state property, or the like. The security property may configure the port to either allow or restrict the multicast traffic flow to/from a specific MAC/IP address. The ACL property may be associated with a list of access controls for allowing the multicast traffic flow to/from a particular ES. The operation state property may indicate an operation state of the port as one of an active state or inactive state.

In a variety of embodiments, the snooping table data 930 may correspond to a snooping table associated with the device 900. As used herein, the snooping table may be a data structure that stores multicast source addresses, multicast destination group addresses, or information about network ports of the device 900. The information about the network ports may include mappings of the network ports to MAC addresses, IP addresses, or the multicast destination group addresses. Additionally, the information about the network ports may include the port properties of the network ports.

In various further embodiments, the port property synchronizing logic 924 may execute a DF election process to generate the DF data 932. In an example, the DF election process may designate one of the device 900 or its peer network device as the DF. The DF data 932 may indicate the device 900 as one of a DF or a non-DF for forwarding the multicast join message. In a scenario where the device 900 is non-DF, the DF data 932 may further indicate which device among peer network devices is elected as the DF. Further, the DF data 932 may indicate a priority order for managing DF state in case of a failure in the currently elected DF.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9 and can include other components that are not explicitly shown in FIG. 9 or might utilize an architecture completely different than that shown in FIG. 9.

Finally, in numerous additional embodiments, data may be processed into a format usable by one or more machine-learning models 926 (e.g., feature vectors), and or other pre-processing techniques. The machine-learning (“ML”) model(s) 926 may be any type of ML model, such as supervised models, reinforcement models, or unsupervised models. The ML model(s) 926 may include one or more of linear regression models, logistic regression models, decision trees, Naïve Bayes models, neural networks, k-means cluster models, random forest models, or other types of ML models.

The ML model(s) 926 can be configured to generate inferences to make predictions or draw conclusions from data. An inference can be considered the output of a process of applying a model to new data. This can occur by learning from at least the port property data 928, the snooping table data 930, and the DF data 932 and using that learning to predict future outcomes. In various embodiments, the ML model(s) 926 may be utilized in DF election process. For example, the ML model(s) 926 may take various inputs such as network traffic, latency parameters, resource utilization parameters, or the like associated with network devices in a multi-homing set and may elect at least one of the network devices as a DF for multi-cast traffic. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 926 may be generated by human/administrator verifications or may compare predicted outcomes with actual outcomes.

Although a specific embodiment for a device 900 suitable for configuration with the port property synchronizing logic for carrying out the various steps, processes, methods, and operations described herein is discussed with respect to FIG. 9, any of a variety of systems and/or processes may be utilized in accordance with embodiments of the disclosure. For example, the device 900 may be in a virtual environment such as a cloud-based network administration suite, or it may be distributed across a variety of network devices or switches. The elements depicted in FIG. 9 may also be interchangeable with other elements of FIGS. 1-8 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network device, comprising:
one or more ports;
a processor; and
a memory communicatively coupled to the processor, wherein the memory comprises a port property synchronizing logic that is configured to:
receive, via a port of the one or more ports, a multicast query message from a host device, wherein the host device is coupled to a multi-homing set including the network device and a peer network device;
update at least one port property of the port based on the multicast query message at the port;
generate a notification message including an Ethernet Segment Identifier (ESI) associated with the port and the updated at least one port property of the port; and
transmit the generated notification message to the peer network device.

2. The network device of claim 1, wherein the ESI indicates an Ethernet Segment (ES) associated with the port on which the multicast query message is received.

3. The network device of claim 1, wherein the notification message further includes an Ethernet Virtual private network Instance (EVI) identifier indicating an EVI on which the multicast query message is received.

4. The network device of claim 1, wherein the port property synchronizing logic is further configured to:
receive a multicast join message from a new host device;
generate a multicast join synch message based on the multicast join message; and
transmit the generated multicast join synch message to the peer network device.

5. The network device of claim 4, wherein the multicast join synch message includes at least one of a new ESI associated with the multicast join message or an Ethernet Virtual private network Instance (EVI) identifier associated with the multicast join message.

6. The network device of claim 4, wherein the port property synchronizing logic is further configured to:
determine whether a state of the port corresponds to a non-designated forwarder (DF) state; and
drop the received multicast join message based on the determination that the state of the port corresponds to the non-DF state.

7. The network device of claim 1, wherein the notification message is configured to synchronize the updated at least one port property with another port of the peer network device that is associated with the ESI.

8. The network device of claim 1, wherein the updated at least one port property indicates the port as a Multicast router (Mrouter) port.

9. The network device of claim 1, wherein the multicast query message corresponds to an Internet Group Management Protocol (IGMP) query message.

10. The network device of claim 1, wherein the multicast query message corresponds to a Protocol Independent Multicast (PIM) hello message.

11. A network device, comprising:
one or more ports;
a processor; and
a memory communicatively coupled to the processor, wherein the memory comprises a port property synchronizing logic that is configured to:
receive, from a peer network device, a notification message including an Ethernet Segment Identifier (ESI) and at least one port property, wherein the network device and the peer network device belong to a multi-homing set coupled to a host device;
identify, from the one or more ports, a port associated with the ESI; and
associate the identified port with the at least one port property.

12. The network device of claim 11, wherein the at least one port property corresponds to a Multicast router (Mrouter) port property.

13. The network device of claim 12, wherein to associate the identified port with the at least one port property, the port property synchronizing logic is further configured to mark the identified port as an Mrouter port.

14. The network device of claim 13, wherein the port property synchronizing logic is further configured to:
receive a multicast join synch message from the peer network device; and
transmit, via the Mrouter port to the host device, a proxy report based on the multicast join synch message.

15. The network device of claim 14, wherein the port property synchronizing logic is further configured to:
determine that a state of the Mrouter port corresponds to a designated forwarder (DF) state; and
transmit, via the Mrouter port, the proxy report to the host device based on the determination that the state of the Mrouter port corresponds to the DF state.

16. The network device of claim 14, wherein the port property synchronizing logic is further configured to receive, from the host device via the Mrouter port, a multicast traffic flow based on the transmitted proxy report.

17. The network device of claim 14, wherein the port property synchronizing logic is further configured to update a snooping table based on receiving the multicast join synch message.

18. The network device of claim 12, wherein to associate the identified port with the at least one port property, the port property synchronizing logic is further configured to mark the identified port as a non-Mrouter port.

19. The network device of claim 11, wherein the ESI indicates an Ethernet Segment (ES) on which a multicast query message is received from the host device.

20. A method, comprising:
in a network device including one or more ports:
receiving, via a port of the one or more ports, a multicast query message from a host device, wherein the host device is coupled to a multi-homing set including the network device and a peer network device;
updating at least one port property of the port based on receiving the multicast query message at the port;
generating a notification message including an Ethernet Segment Identifier (ESI) associated with the port and the updated at least one port property of the port; and
transmitting the generated notification message to the peer network device.
